(19) United States
(12) Patent Application Publication
(10) Pub. No.: US 2020/0131420 A1
(43) Pub. Date: Apr. 30, 2020

(54) METHOD AND COMPOSITION OF MATTER FOR REDUCING LOST CIRCULATION

(71) Applicant: Bastlab, LLC, Omaha, NE (US)

(72) Inventors: John Carpenter, Omaha, NE (US); Tapan Chatterjee, Omaha, NE (US)

(73) Assignee: Bastlab, LLC, Omaha, NE (US)

(21) Appl. No.: 16/493,781

(22) PCT Filed: Mar. 15, 2018
(86) PCT No.: PCT/US18/22714

§ 371 Date: Sep. 13, 2019

Related U.S. Application Data
(60) Provisional application No. 62/472,979, filed on Mar. 17, 2017.

(51) Int. Cl. C09K 8/035; C09K 8/508; C09K 8/516

(52) U.S. Cl. CPC C09K 8/035; C09K 2208/08; C09K 8/516; C09K 8/508

(57) ABSTRACT

The present invention provides a method and a composition for eliminating or reducing the effects of loss of circulation events. In particular, the present invention provides a fiber-based loss of circulation material which seals fractures during drilling operations.

### RELATED APPLICATIONS

The present application claims priority to U.S. Provisional Application No. 62/472,979 filed Mar. 17, 2017.

### FIELD OF INVENTION

The present invention is related in general to drilling fluids and, in particular, to a method and a composition of matter for eliminating or reducing the effects of loss of circulation events which can occur in drilling as well as cement pouring operations.

### BACKGROUND OF THE INVENTION

In conventional drilling operations, a drill bit is first attached to a drill pipe and then directed through a drill hole into the ground. Normally, the drill hole is lined with a large-diameter concrete pipe called a casing that prevents the hole from collapsing. Once in the drill hole, the drill bit is then rotated to remove materials from the bottom of the drill hole. As the drilling progresses, drilling mud (normally a mixture of water, clay, weighting material and chemicals) is circulated though the drill pipe to float the rock cuttings to the surface of the drill hole.

The circulation of drilling mud is performed under pressure. To maintain the drilling mud under pressure, the drilling mud must be contained within the drill hole. Loss of circulation of the drilling mud (generically referred to as loss of circulation) in the drilling system occurs when the flow of mud is interrupted due to the uncontrolled flow of the drilling mud into a formation. This can result for several reasons including induced fractures caused by excessive downhole pressures or drilling into formations which are inherently fractured, cavernous, or have high permeability. In partial loss of circulation, mud continues to flow to the surface with some loss into the formation. In total loss of circulation, all the mud flows into the formation with no return to the surface.

With respect to induced fractures, all well-bores have at least some small fractures caused by drilling a borehole as well as those caused by wall instabilities, moving stresses, and the like. If these small fractures are not immediately sealed, the fractures can propagate and enlarge to allow larger particles within the fractures that prevent filter cake bridging and associated sealing. When larger material becomes lodged within the fractures, creating permeability that the gelatinous filter cake cannot bridge, it will allow pressure to reach the point of fracture propagation and further enlarge the fracture to cause lost circulation of drilling fluids.

To prevent either partial or total loss of circulation, equations 1 and 2 below show the conditions that must be maintained to avoid fracturing the formation during drilling (1) and tripping in (2), respectively:

λ_{q}=Δλ_{af}<λ_{frac} and (1)

λ_{eq}=λₘₕ+Δλₛ<λ_{frac} (2)

where λₘₕ=static mud weight, Δλ_{af}=additional mud weight caused by friction pressure loss in annulus, Δλs=additional mud caused by surge pressure, λ_{frac}=formation-pressure fracture gradient in equivalent mud weight, and λ_{eq}=equivalent circulating density of mud.

Loss of circulation causes over $8 billion in lost revenue in the oil industry each year. For each individual drilling well, the loss can be as little as the loss of a few dollars of drilling fluid, or as disastrous as a blowout and loss of life, so close monitoring of flow from the well to quickly assess and control lost circulation is needed. If the amount of fluid in the wellbore drops due to lost circulation (or any other reason), hydrostatic pressure is reduced which can allow a gas or fluid (which is under a higher pressure than the reduced hydrostatic pressure) to flow into the wellbore.

Another consequence of lost circulation is dry drilling. Dry drilling occurs when fluid is completely lost from the well bore without actual drilling coming to a stop. The effects of dry drilling range from as minor as destroying a bit to as serious as major damage to the well-bore requiring a new well to be drilled. Dry drilling can also cause severe damage to the drill string, including snapping the pipe and the drilling rig itself.

To counter loss of circulation issues, various chemicals and mixtures are commonly added to the drilling mud. These loss control materials (LCMs) act to form barriers to flow on the borehole wall or in openings connected to the wall. These LCMs must be compatible with all the other functions to be performed by the drilling fluid and with all the chemicals added to produce the desired properties of the drilling fluid. In addition, the chemicals are preferably non-toxic and biodegradable. Although many different formulations of LCMs are commonly used, the LCMs currently available fail to provide the needed properties to effectively stop, repair or reduce the effects of most loss of circulation events.

What is needed is a LCM which minimizes the risk of loss of circulation and which allows for quick restoration of circulation pressures when a loss of circulation event occurs. Further, what is needed is a LCM which is effective at forming a seal over a bridge that has been formed in a fracture or cavern or over a highly permeable formation. Further, what is needed is a LCM which is effective at producing a matting or caking effect to assist forming a seal. What is further needed is a LCM which includes a gradation of particle sizes, shapes and rigidity.

The present invention provides these needed advantages by providing a LCM which creates an effective seal while at the same time reducing frictional drag between the drill pipe and the borehole wall, aiding in running casing or liners in the well and improving the quality of logs run in the well. Further, the present invention provides the needed advantages above by using a natural, eco-friendly LCM product.

### SUMMARY OF THE DISCLOSURE

To minimize the limitations found in the prior art and other limitations that will be apparent upon the reading of the specification, a preferred embodiment of the present invention provides a method and a composition of matter for eliminating or reducing the effects of loss of circulation events. In particular, the present invention provides a fiber-based loss of circulation material which seals fractures during drilling operations. Further, the fiber-based LCM of the present invention may preferably be recovered and recycled while still allowing the drill solids to be discarded using solid controlling equipment.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and to improve the understanding of the various elements and embodiments of the invention. Furthermore, elements that are known to be common and well understood to those in the industry are not depicted in order to provide a clear view of the various embodiments of the invention. Thus, it should be understood that the drawings are generalized in form in the interest of clarity and conciseness.

FIG. 1 is a chart illustrating a first set of steps within a first method of the present invention.

FIG. 2 is a chart illustrating a second set of steps within a first method of the present invention.

FIG. 3 is a chart illustrating a third set of steps within a first method of the present invention.

### DETAILED DESCRIPTION OF THE DRAWINGS

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

According to the present invention, a preferred formulation and method of creating a fiber-based loss control material (LCM) is provided. According a preferred embodiment, the fiber-based LCM of the present invention is preferably combined with drilling mud to circulate in a well bore during drilling operations. During a loss of circulation event, the fiber-based LCM of the present invention is engineered to minimize and/or repair conditions creating a loss.

According to the present invention, the fiber-based LCM of the present invention is preferably provided for use as a treatment fluid to be added to drilling mud. The treatment fluid of the present invention preferably includes a mixture of ingredients which includes fiber-based LCM which includes cellulosic/hemi-cellulosic material. Preferably, the fiber-based LCM for use with the present invention is formed from a natural, eco-friendly product.

According to further preferred embodiment, the fiber-based LCM is preferably formed of bast fiber cellulosic material (fiber and xylem portion of the plant). Preferably, the bast fiber may be obtained from a bast fiber rich plant which may include plants and plant fibers such as: Flax, Hemp, Jute, Kenaf, Kudzu, Nettle, Okra, Paper Mulberry, Ramie, Roselle hemp and the like.

According to a further aspect of the present invention, the bast fibers are preferably combined with a combination of ingredients which may include one or more of the following ingredients: a gum, a gelling agent, a pH balancing agent, a weighting agent and/or a high absorbent agent to act as a catalyst.

According to a preferred embodiment, the fiber-based LCM is preferably formed and processed to have a specific gravity in a range from about 1.25 to about 1.5, and a median particle size in a range from about 80 Mesh to 110 Mesh value (0.177 mm to 0.149 mm). According to a further preferred embodiment, the bulk density of the fiber-based LCM preferably varies from 0.4 to 0.55 gm/cc.

According to a further aspect of the present invention, once the fiber-based LCM of the present invention is processed and formed to the preferred characteristics, the fiber-based LCM is then preferably mixed with base fluids and other ingredients to create a loss prevention treatment fluid. According to one aspect of the present invention, the treatment fluid is preferably polysaccharide based. According to a further preferred embodiment, the treatment fluid preferably has a liquor ratio of 1:10 and the lost-circulation material is in a concentration in a range of about 10% to 15% weight by volume of the treatment fluid.

In a preferred use, the treatment fluid of the present invention is preferably added to drilling mud prior to the start of the drilling process. According to a further preferred embodiment, the treatment fluid preferably has a sealing pressure of at least 20 psi. According to a further preferred embodiment, the treatment fluid preferably has a sealing pressure of at least 50 psi. According to a further preferred embodiment, the treatment fluid preferably has a sealing pressure of at least 100.

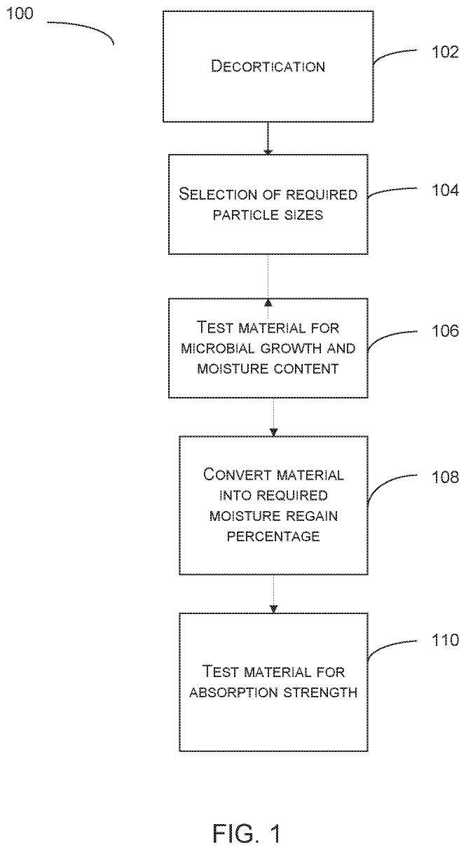

With reference now to FIGS. 1-3, a first preferred method for producing and using the loss prevention material of the present invention will now be disused.

As shown in FIG. 1, the first steps 100 of the present invention preferably include the step of decortication 102. Preferably, the decortication 102 process includes the decortication of stocks and the separation of plant core materials from the plant body by a mechanical process. Since the valuable fibers are located in the phloem, they are preferably separated from the xylem material (“woody core”), and sometimes also from epidermis. The process for this is called retting and can be performed by micro-organisms either on land, in water, or by chemicals (for instance high pH and chelating agents) or by pectinolytic enzymes.

Further in this process, spinnable fibers are preferably separated from the stock and grounded to required particle sizes suitable for the loss prevention process. According to a preferred embodiment, the particles may preferably be sent to a hammer mill for grinding.

As discussed above, the preferred plant fibers for the present invention may include nature plant fibers produced from bast fiber cellulosic material (fiber and xylem portion of the plant). Preferably, the bast fiber may be obtained from a bast fiber rich plant which may include plants and plant fibers such as: Flax, Hemp, Jute, Kenaf, Kudzu, Nettle, Okra, Paper Mulberry, Ramie, Roselle hemp and the like.

Following decortication and grinding 102, the next step 104 preferably includes the selection of required particle sizes. Preferably, the selected particles have a specific gravity in a range of about 1.25 to about 1.5, and a median particle size in a range from about 80 Mesh to 110 Mesh value (0.177 mm to 0.149 mm). According to a further preferred embodiment, the particles are selected so that the resulting bulk density of the lost-circulation material preferably varies from 0.4 to 0.55 gm/cc.

Following the selection of particles 104, the resulting materials are preferably tested for microbial grown and moisture content in step 106 and further processed in step 108 to produce a 14% regain. Thereafter, the materials are preferably further tested for absorption strength in step 110.

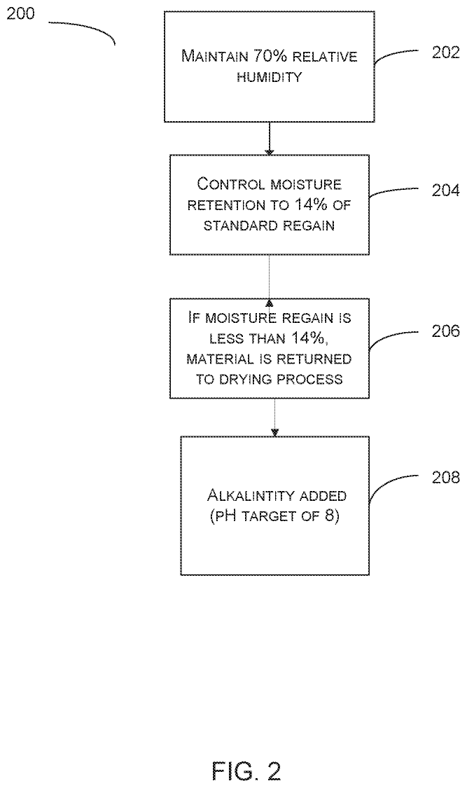

As further shown in FIG. 2, during the processing of the materials, the relative humidity is preferably maintained 202 in a range of 60%-80% (ideally 70%) and the moisture retention of the materials is preferably maintained between 5%-30% (ideally 14%) of standard regain 204. At step 206, if the moisture regain is determined to be too low (less than 14% in the preferred case), then the material is returned to a drying process until the correct regain levels are achieved. Further, at step 208, alkalinity is preferably added to achieve a target pH in a range of 7.5-8.5 (ideally 8 in a preferred embodiment). Thereafter, at step 210, the material is then preferably mixed with Xanthan dispersible material. Preferably, the Xanthan dispersible material is added until it is in a range of 5%-30% of the total weight of mixture. Ideally, the Xanthan is approximately 15% of the total weight of the total mixture.

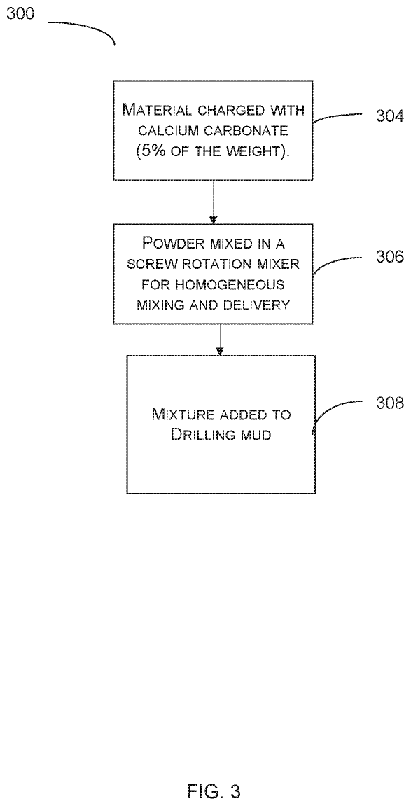

As further shown in FIG. 3, in the next method steps 300, the material at step 302 is then preferably charged with sodium poly-acrylate until the sodium poly-acrylate is in a range of 1%-10% of the total weight of the mixture. Ideally, the sodium poly-acrylate is approximately 5% of the total weight of the total mixture. Thereafter, at step 304 the material is then preferably charged with calcium carbonate until the calcium carbonate is in a range of 1%-10% of the total weight of the mixture. Ideally, the calcium carbonate is approximately 5% of the total weight of the total mixture. Thereafter, at step 306, the total mixture is preferably mixed. Ideally, the total mixture is mixed in a screw rotation mixture unit the mixture is completely mixed and homogenous. Thereafter, at step 308, the mixture is then preferably added to drilling mud as needed.

According to a preferred embodiment, kanee and hemp core are used to provide cellulose and hemicellulose for the decortication process. Although various plants may also be used (as discussed above) and the compositions of each may vary, exemplary compositions of kanee and hemp cores for use with the present invention are provided below:

CHEMICAL COMPOSITION OF KENAE AND HEMP CORE

| | KENAF | HEMP |
|---|---|---|
| CHEMICAL COMPOSITION | | |
| WATER | 7%-10% | 10% |
| CELLULOSE | 51%-52% | 45%-52% |
| HEMICELLULOSE | 20%-25% | 15%-20% |
| LIGNIN | 17% | 20%-30% |
| ASH | 2.9%-4.2% | 4%-5% |
| MAJOR ELEMENTS | | |
| NITROGEN | .24% | 0.4%-1% |
| PHOSPHORUS | .06% | .2%-.5% |
| POTASSIUM | .6% | .96%-1.5% |
| SODIUM | .23% | .09% |
| CALCIUM | .18% | .89%-1.4% |
| MAGNESIUM | .17% | .06%-.02% |
| SULPHUR | .1% | .16% |
| MINOR ELEMENTS (PPM) | | |
| MANGANESE | 5 | — |
| COPPER | 7 | .6 |
| ZINC | 14 | — |
| BORON | 21 | — |
| CHEMICAL PROPERTIES | | |
| FLAMMABILITY | FLAMMABLE | FLAMMABLE |
| HIGHER HEAT CAPACITY | 4.00 KCAL/KG | 4.055 KCAL/KG |
| LOWER HEAT CAPACITY | 3.675 KCAL/KG | 3.715 KCAL/KG |

The foregoing description of the preferred embodiment of the present invention has been presented for the purpose of illustration and description. It is not intended to be exhaustive or to limit the invention to the precise form disclosed.

It should further be understood that many modifications and variations are possible in light of the above teachings. It is intended that the scope of the present invention not be limited by this detailed description, but by the claims and the equivalents to the claims appended hereto. For instance, the present invention teaches a LCM for addition to drilling mud to be used throughout the drilling process. It should, however, be understood that various compositions of the LCM of the present invention may be further selectively added at various stages in the drilling process in response to lost circulation events or other changes in drilling conditions.

Further, the above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for eliminating or reducing lost circulation from a well, wherein the method comprises:
introducing powder dissolved in water as a treatment fluid into at least a portion of the well, wherein the treatment fluid comprises:
a) a lost-circulation material;
b) wherein the lost-circulation material comprises cellulose;
c) wherein the lost-circulation material is made from bio-degradable products;
d) wherein the lost-circulation material has a specific gravity in a range from about 1.25 to about 1.5;
e) wherein the lost-circulation material has a median particle size in a range from about 80 US Mesh to 110 Mesh value (0.177 mm to 0.149 mm); and
f) wherein the bulk density varies from 0.4 to 0.55 gm/cc.

2. The method according to claim 1, wherein the lost-circulation material is comprised of at least 50% bast fiber cellulosic material.

3. The method according to claim 1, wherein the lost-circulation material comprises: cellulosic material, a weighting agent and positive water solubility-maintained polysaccharides.

4. The method according to claim 3, wherein the cellulosic material is comprised of bast fiber obtained from the xylem portion of a plant.

5. The method according to claim 1, wherein the lost-circulation material has a median particle size in a range from 80 Mesh to 110 Mesh.

6. The method according to claim 1, wherein the lost-circulation material is in a concentration of at least 1:10 liquor ratio of the loss prevention fluid.

7. The method according to claim 1, wherein the lost-circulation material is in a concentration in a range of about 10% to 15% weight by volume of the loss prevention fluid.

8. The method according to claim 1, wherein the loss prevention fluid has a sealing time of less than 5 minutes.

9. The method according to claim 1, wherein the loss prevention fluid is a drilling fluid.

10. The method according to claim 1, wherein the loss prevention fluid is a polysaccharide-based fluid.

11. The method according to claim 1, wherein the loss prevention fluid has a sealing pressure of at least 20 psi.

12. The method according to claim 1, wherein the loss prevention fluid has a sealing pressure of at least 100 psi.

13. The method according to claim 1, wherein the median particle size and the concentration of the lost-circulation material is selected such that the loss prevention fluid has a sealing pressure in a range of about 50 to about 100 psi (about 0.3 to about 0.7 MPa).

14. The method according to claim 13, wherein the median particle size of the lost-circulation material is selected such that the loss prevention fluid has a sealing pressure at the bottom-hole pressure of the well.

15. A loss prevention fluid comprising lost-circulation material, wherein the lost-circulation material comprises cellulosic material.

16. The loss prevention fluid of claim 15, wherein the lost-circulation material is comprised of at least 50% bast fiber cellulosic material.

17. The loss prevention fluid of claim 16, wherein the lost-circulation material comprises: cellulosic material, a weighting agent and positive water solubility maintained polysaccharides.

18. The loss prevention fluid of claim 17, wherein the cellulosic material is comprised of bast fiber obtained from the xylem portion of a plant.

19. The loss prevention fluid of claim 18, wherein the lost-circulation material has a median particle size in a range from 80 Mesh to 110 Mesh.

20. The loss prevention fluid of claim 19, wherein the lost-circulation material is in a concentration of at least 1:10 liquor ratio of the loss prevention fluid.

21. The loss prevention fluid of claim 20, wherein the lost-circulation material is in a concentration in a range of about 10% to 15% weight by volume of the loss prevention fluid.

22. The loss prevention fluid of claim 21, wherein the loss prevention fluid has a sealing time of less than 5 minutes.

23. The loss prevention fluid of claim 22, wherein the loss prevention fluid is a drilling fluid.

24. The loss prevention fluid of claim 23, wherein the loss prevention fluid is a polysaccharide based fluid.

25. The loss prevention fluid of claim 24, wherein the loss prevention fluid has a sealing pressure of at least 20 psi.

26. The loss prevention fluid of claim 25, wherein the loss prevention fluid has a sealing pressure of at least 100 psi.

27. The loss prevention fluid of claim 26, wherein the median particle size and the concentration of the lost-circulation material is selected such that the loss prevention fluid has a sealing pressure in a range of about 50 to about 100 psi (about 0.3 to about 0.7 MPa).

28. The loss prevention fluid of claim 27, wherein the median particle size of the lost-circulation material is selected such that the loss prevention fluid has a sealing pressure at the bottom-hole pressure of the well.
